(19) United States
(12) Patent Application Publication
(10) Pub. No.: US 2018/0295932 A1
(43) Pub. Date: Oct. 18, 2018

(54) Customizable Therapeutic or Occupational Shoe Sole and Methods of Manufacturing the Same

(71) Applicant: Peter Wong, Sacramento, CA (US)

(72) Inventor: Peter Wong, Sacramento, CA (US)

(21) Appl. No.: 15/950,094

(22) Filed: Apr. 10, 2018

Related U.S. Application Data
(63) Continuation-in-part of application No. 13/477,055, filed on May 22, 2012.
(60) Provisional application No. 61/495,911, filed on Jun. 10, 2011.

(51) Int. Cl. A43B 13/12; A43B 13/02; A43B 13/18; A43B 3/24; A43B 7/32; B32B 5/26

(52) U.S. Cl. CPC A43B 13/127; A43B 13/026; A43B 13/181; A43B 3/246; B32B 2437/02; B32B 5/26; B32B 2262/101; B32B 2262/106; A43B 7/32

(57) ABSTRACT

A customizable therapeutic or occupational shoe sole and methods of producing the shoe sole are provided. The shoe sole includes an outsole, a midsole made from a shock absorptive material and an energy returner integrated with the midsole via an opening in the midsole. The energy returner includes a front lever arm secured to a front bottom recess of the midsole and includes a rear lever arm secured to a rear top recess of the midsole. The rear lever arm includes a lever arm joint for coupling the rear lever arm to the front lever arm. In some embodiments, shoe sole includes an adjustable base to enhance body mass control of the subject via a plantar flexor tendon, thereby customizing for unique biomechanics by relocating the adjustable base relative to the rear lever arm.

### CROSS REFERENCE TO RELATED APPLICATIONS

This application is a Continuation-in-Part of and claims the priority of Non-Provisional application Ser. No. 13/477,055, filed on May 22, 2012 (SR-1101), which application is related to and claims the priority of Provisional Application No. 61/495,911, filed on Jun. 10, 2011, both applications are incorporated herein in their entirety by this reference.

### BACKGROUND

The present invention relates to therapeutic and occupational shoe soles and methods of manufacturing the same. These shoe soles combine unique features, compositions, and structures in order to provide the subject with enhanced comfort, increased mobility, reduced healing time and disability prevention. The disclosed shoe soles are of therapeutic use for medical patients who require enhanced pedorthic qualities or used for subjects with physically demanding occupations.

Shoe soles have been manufactured since prehistory. Traditional shoe soles functioned to merely protect the foot from abrasive surfaces and against injury. These shoe soles included leather or other animal skin wrappings, reed or woven soles, and wooded soles.

Modern shoe soles still primarily protect the foot. Additionally, modern soles are designed for wear resistance, enhanced comfort, support and stability. Recently, there has been increased interest in shoe soles which provide therapeutic benefits through arch support and “rocker” designs to minimize shock during movement, and promotion of proper alignment. Modern soles may include traditional materials and may include contemporary materials such as synthetic plastics and rubbers, natural rubbers such as latex, resins, and other composites.

Advanced shoe sole designs may include air bladders, springs, honeycomb structures and other supports in order to ensure therapeutic benefits. However, despite the current maturity of shoe sole designs, there is always a need for improved sole designs that increase wearer comfort, mobility and support.

In view of the foregoing, a customizable therapeutic/occupational shoe sole and methods for manufacturing the same are provided. The present invention provides a novel shoe sole design for reduced healing time, increased comfort, increased mobility and enhanced postural stability for a wearer. The present therapeutic/occupational sole includes a novel energy returner in conjunction with lateral and medial supports, and a rocker design to provide superior orthopedic function.

### SUMMARY

The present invention discloses a therapeutic/occupational shoe sole and methods of producing the shoe sole. The shoe sole increases wearer comfort, decreases healing time post injury, reduces injury risk and/or reduces energy required at the toe-off stance while walking, thereby increasing mobility for weaker, arthritic patients, injured individuals, or reduces stress injury risk for subjects with physically demanding occupations.

The therapeutic/occupational shoe sole has a toe region, a ball region, an arch region and a heel region. Some embodiments of the therapeutic shoe sole include an outsole, an energy returner and a midsole.

The outsole includes grips and comes in contact with the ground. The outsole provides the foot protection. The outsole may be coupled to the other elements via adhesive, stitching, or other known technique. The energy returner includes a front lever arm secured to a front bottom recess of the midsole and also includes a rear lever arm secured to a rear top recess of the midsole, wherein the rear lever arm includes a lever arm joint for coupling the rear lever arm to the front lever arm.

In some embodiments, the shoe sole also includes an adjustable base configured to enhance body mass control of the subject via a plantar flexor tendon of the subject, thereby customizing for unique biomechanics of the subject by relocating the adjustable base relative to the rear lever arm.

Note that the various features of the embodiments described above may be practiced alone or in combination. These and other features of embodiments of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an example bottom view illustration of a first outsole embodiment for the therapeutic shoe sole, in accordance with some embodiments;

FIGS. 2A and 2B are example bottom and front view, respectively, illustrations of a second outsole embodiment for the therapeutic shoe sole, in accordance with some embodiments;

FIGS. 3A and 3B are example side view illustrations of the therapeutic shoe sole, in accordance with some embodiments;

FIG. 4A is an example cross sectional side view illustration of the therapeutic shoe sole, in accordance with some embodiments;

FIGS. 4B-D are example cross sectional front view illustrations of the therapeutic shoe sole at various spacing, in accordance with some embodiments;

FIGS. 5A and 5B are example cross sectional side and top view illustrations, respectively, of the midsole with energy return strip of the therapeutic shoe sole, in accordance with some embodiments;

FIGS. 6A and 6B are example side and top view illustrations, respectively, of a first embodiment of the energy return strip of the therapeutic shoe sole while FIG. 6C is a side view of another embodiment of the energy return strip of the therapeutic shoe sole, in accordance with some embodiments;

FIGS. 7A and 7B are example side and top view illustrations, respectively, of a second embodiment of the energy return strip of the therapeutic shoe sole, in accordance with some embodiments;

FIG. 8 is an example flow chart diagram for the manufacturing of the therapeutic shoe sole, in accordance with some embodiments;

FIG. 9 is an example cross sectional top view illustration of a data feedback embodiment of the therapeutic shoe sole, in accordance with some embodiments;

FIGS. 10-16B illustrate another embodiment of an energy returning shoe including an energy returner having a front lever arm, a rear lever arm and an adjustable base;

FIGS. 17A-17E illustrate customization of the embodiment of the energy returning shoe of FIGS. 16A-16B and

FIGS. 18A and 18B depicts yet another embodiment, wherein instead of a cutout to fill in a hole, a flap facilitates the assembly of gait restoring middle shoe sandwich.

In the drawings, like reference numerals are sometimes used to designate like structural elements. It should also be appreciated that the depictions in the figures are diagrammatic and not necessarily to scale.

### DETAILED DESCRIPTION

Embodiments of the present invention will be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates generally to therapeutic/occupational shoe sole designs. In particular, the present shoe sole design includes elements of medial and lateral supports, enhanced heel cushioning, and an energy returner, e.g., an energy return strip or an energy returning lever arm combination. The unique energy returner includes one or more layers of glass fiber laminated to one or more layers of carbon fiber. The unique geometry of the energy returner, in conjunction with its laminate composition reduces pressures to the forefoot area, and reduces effort when walking during the toe-off stance. Further, in conjunction with medial and lateral supports, the energy returner provides stability to the entire plantar surface when entering the swing phase.

### I. Outsole Embodiments

The therapeutic shoe sole disclosed herein in terms of various embodiments may utilize a number of different outsole designs. Outsoles should be designed to conform to the midsole in conjunction with the medial and lateral supports, as well as the energy return strip. Further, in some embodiments, it may be desirable for the outsole to be a “rocker” type design to reduce shock during walking. Additionally, in many embodiments, it may be desirous that the outsole be designed to provide a solid grip to the intended walking surface. Further design considerations for the outsole include wear resistance, fashion ability, and material costs, availability, weight and workability. In many embodiments, the shoe outsoles may be manufactured from natural rubbers or synthetics, such as polyurethane. Of course, in alternate embodiments, other materials may be selected for the composition of the outsole, including leather, resins, wood, and composites. Further, the outsole may be comprised of any combination of the above referenced materials, as is known in the art.

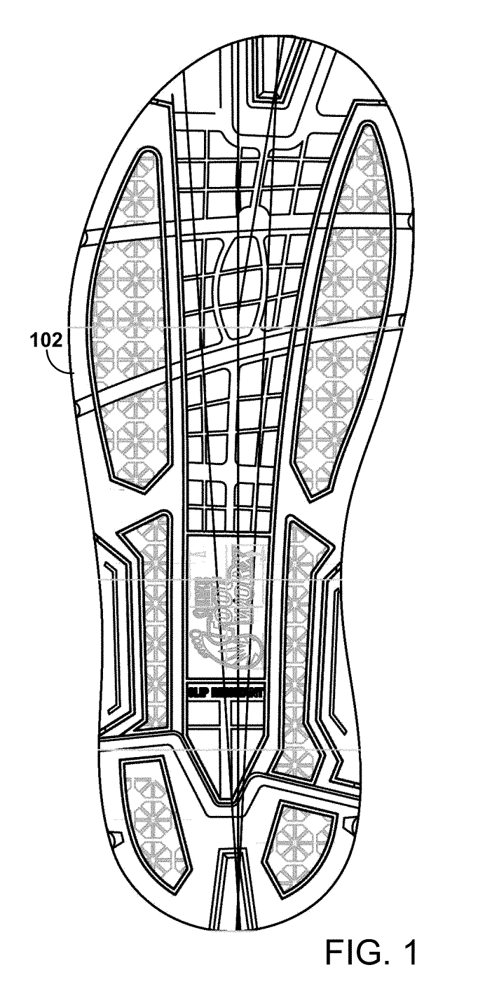

To facilitate discussion, FIG. 1 is an example bottom view illustration of a first outsole embodiment 102 for the therapeutic shoe sole, in accordance with some embodiments. The illustrated outsole includes hexagonal florets to grip smooth surfaces, and parallelogram grips down the center of the outsole for general traction, wear resistance and stiffness.

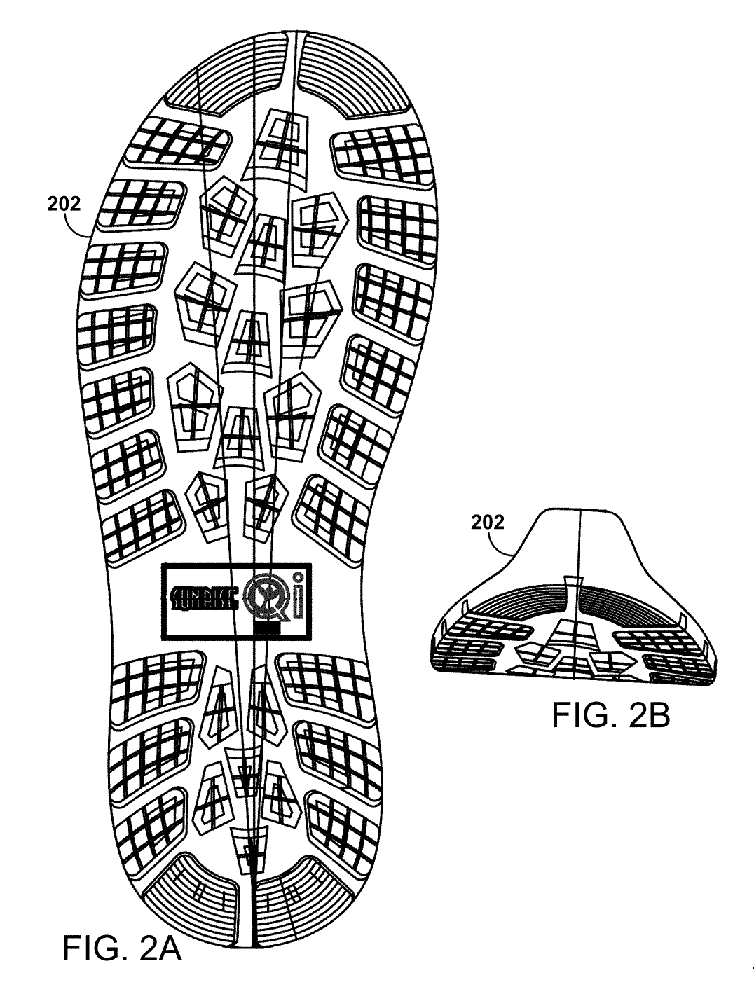

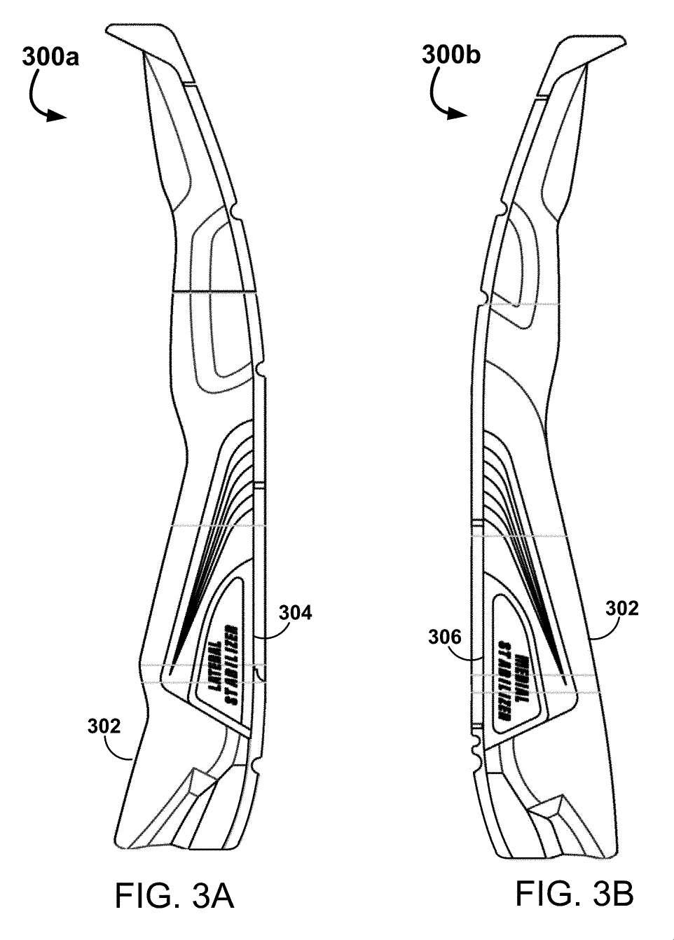

A second outsole embodiment 202 may be seen at FIG. 2A. This second outsole embodiment 202 has wider spaced grips, and is suitable for rougher terrain, and may be better suited for wet conditions. The heel and toe of the outsole includes ribbing for improved traction when the heel is placed, and toe-off stance, respectively.

FIG. 2B is a frontal view of the second outsole embodiment 202, in accordance with some embodiments. The outsole may, in some embodiments, turn up at the toe and heel regions, as illustrated. This curvature is known as a “rocker” design. Rocker designs promote a rolling heel-to-toe gait which may reduce shock and increases foot comfort. However, rocker style shoes may also be more difficult to balance in, and as such, embodiments of the present invention are also directed toward shoe designs which are relatively less curved than traditional rocker style designs.

Also of note, any suitable tread design may be utilized in conjunction of some embodiment of the therapeutic shoe sole. Treads may be designed for particular surfaces, applications, or aesthetics. These variations are considered to be entirely within the scope of the disclosure, although separate mention or illustration of every possible variation would not be practical. It is obvious, however, that persons skilled in the art will be able to design an unlimited range of variations to suit specific applications.

### II. Energy Return Strip Reinforced Midsole Embodiments

As noted above, the therapeutic shoe sole includes the outsole coupled to medial and lateral supports, and a midsole including an energy return strip. This combination of features, and in particular the unique energy return strip, enables the therapeutic shoe sole to reduce healing time in medical patients, increase shoe comfort, increase mobility and reduce energy requirements during the toe-off stance during gait.

FIGS. 3A and 3B are example side view illustrations of the therapeutic shoe sole, in accordance with some embodiments. The outside view is shown at 300a in relation to FIG. 3A. Here the sole 302 is illustrated with a lateral support 304 affixed between the heel and pad/ball regions of the shoe. Conversely, the inside view is illustrated at 300b in relation to FIG. 3B, where the medial support 306 may be seen.

Medial and lateral supports may include stiffening elements which provide strength along the length of the sole. These supports, in conjunction with the energy return strip, may provide the wearer with stability to the entire plantar surface entering into the swing phase.

When the heel is off the ground, the foot is kept in balance by the solid and stiff support members, preventing over-supination or pronation of the foot. When the ball of the foot touches the ground, and the toes are bent, the energy return strip provides force to reduce the stress focus on the toes, and assists the foot to easily lift upward. This reduces the energy required to roll from the oblique axis to the hallux on the traverse axis.

The medial and lateral supports may be comprised of any suitably stiff or ridged materials. In some embodiments the medial and lateral supports are comprised of a plastic, resin or other synthetic polymer material. In alternate embodiments, the medial and lateral supports may be comprised of metal. In yet other embodiments, the medial and lateral supports may be comprised of carbon and/or glass fiber.

In addition to more clearly illustrating the geometry and location of the medial and lateral supports, FIGS. 3A and 3B further illustrate a therapeutic “rocker” sole design. Typical athletic shoes that include a rocker design maintain a consistent curvature along the bottom of the shoe. In contrast, some embodiments, such as the one illustrated here, incorporate a flat shoe bottom from the pad/ball region to the beginning of the heel region. The heel then turns up, as does the toe region extending into the pad/ball region. The benefit of this design includes increased balance over continually curved designs, and yet increased comfort and foot alignment during walking.

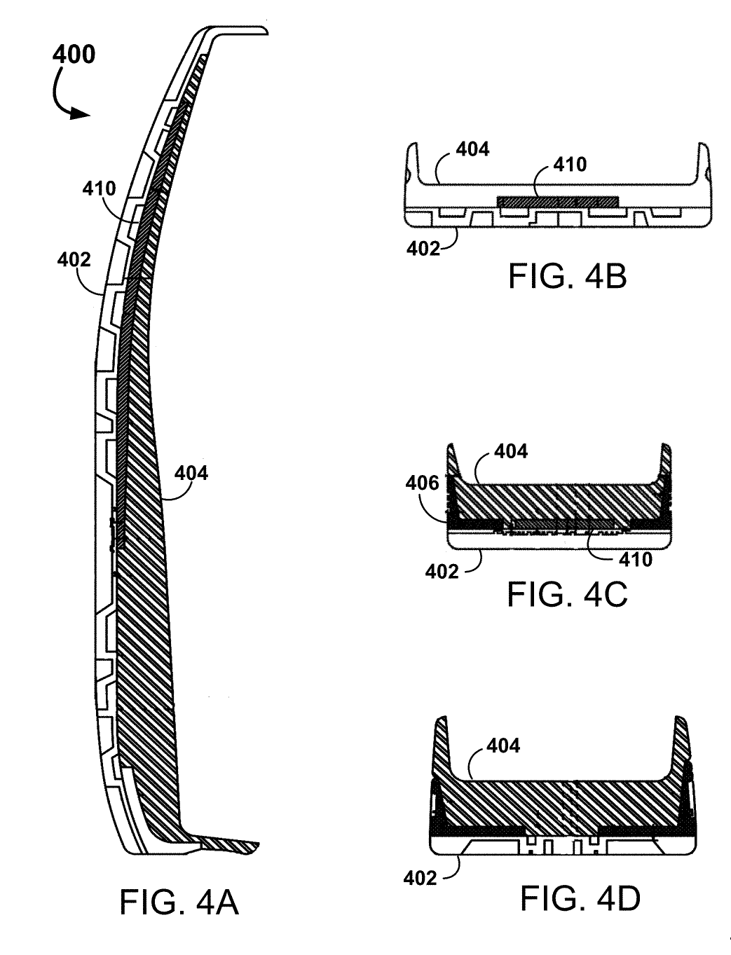

Continuing, FIG. 4A is an example cross sectional side view illustration 400 of the therapeutic shoe sole, in accordance with some embodiments. Here the outsole 402 with treading is seen in close contact with the energy return strip 410 and midsole 404. The midsole 404 may include foam cushioning, elastomer, rubber, or any other suitable material. Generally, midsole material may be selected for moisture properties, shock absorption, weight, wear resistance and ability to mold to the foot. In some embodiments, the midsole 404 may include a single material. In alternate embodiments, the midsole 404 may include a combination of materials, as is desired. In some embodiments, the heel portion of the midsole may include a silicon material for its shock absorptive properties. Also, note that, in some embodiments, the midsole increases in thickness across the arch and into the heel portion. This increasing thickness is in response to the weight distribution on the foot when walking, and in support of the arch of the foot.

FIGS. 4B-D are example cross sectional front view illustrations of the therapeutic shoe sole at various spacing, in accordance with some embodiments. FIG. 4B is a cross section of the sole at the pad/ball or toe region. The midsole 404 portion is thin in these regions, and the energy return strip 410 is present. The outsole 402 can also be seen protecting the bottom of the sole.

FIG. 4C is a cross section of the sole at the arch region. Again, the outsole 402 is present, as is the midsole 404 and energy return strip 410. Additionally, at this region are the medial and lateral supports 406. The medial and lateral supports, in this embodiment, are L shaped structures which extend up the side of the midsole and down along the bottom of the midsole between the outsole. By overlapping the energy return strip 410 and medial and lateral supports 406 in this region the desired support can be achieved.

FIG. 4D is a cross section of the sole at the heel region. Again, the outsole 402 is present, as is the midsole 404 and medial and lateral supports 406. The energy return strip does not extend down to the heel region in this embodiment. Note that, in this embodiment, the base of the medial and lateral supports 406 extends further toward the center of the sole at this region.

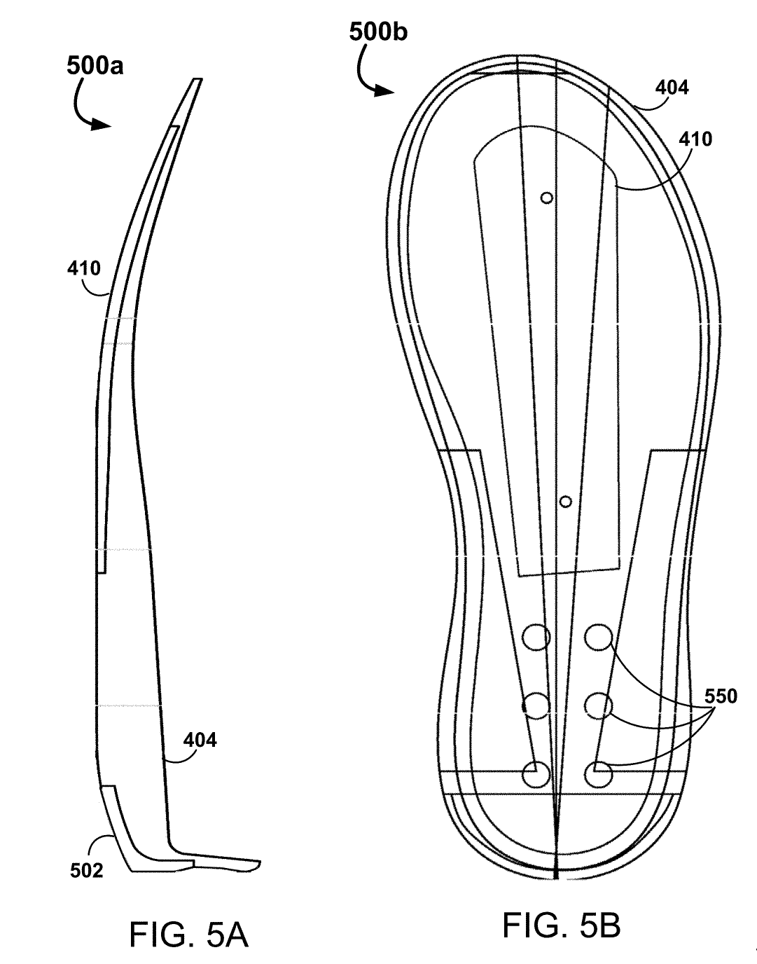

FIGS. 5A and 5B are example cross sectional side and top view illustrations, respectively, of the midsole 404 with energy return strip 410 of the therapeutic shoe sole, in accordance with some embodiments. In this illustration at the base of the heel region is a silicon pad 502 to further enhance foot comfort and shock absorption. The top view 500b of the midsole 404 and energy return strip 410 illustrates the geometry and location of the energy return strip 410. Additionally, one or more cutouts 550 may be made in the midsole 404 to reduce overall sole weight.

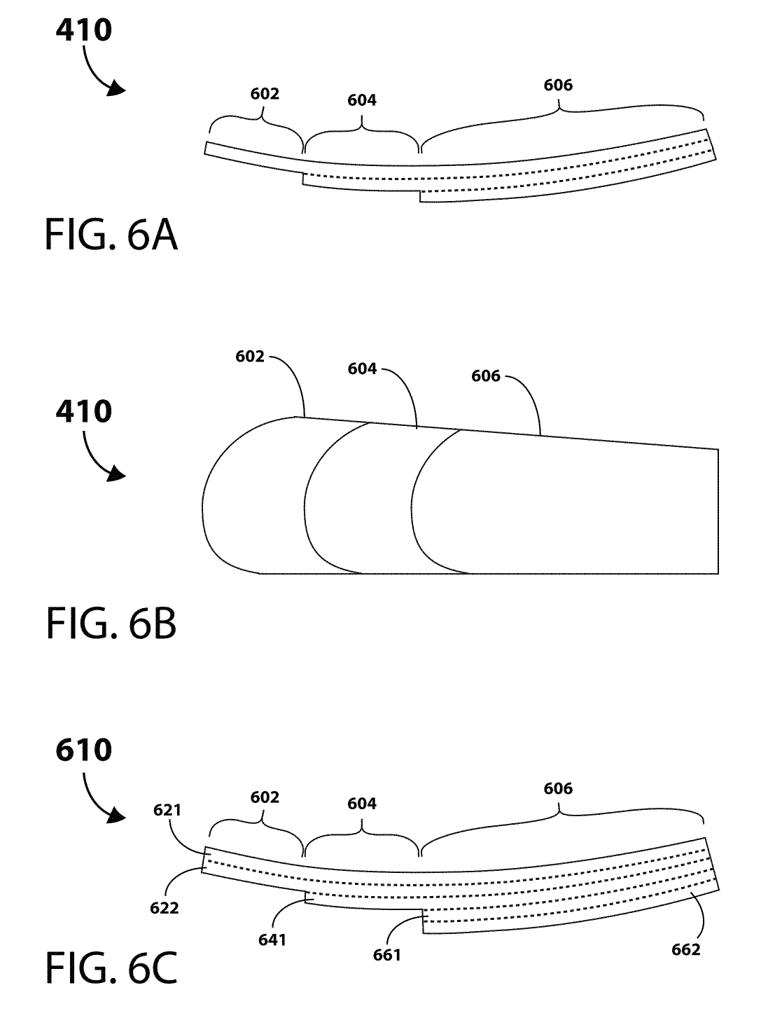

FIGS. 6A and 6B are example side and top view illustrations, respectively, of a first embodiment of the energy return strip 410 of the therapeutic shoe sole, in accordance with some embodiments. The energy return strip 410 may, in some embodiments, may include one or more layers of carbon fiber in combination with one or more layers of glass fiber laminated together. In some embodiments, the energy return strip 410 may include three sections 602, 604 and 606, respectively, with varying layers and thicknesses. In some particular embodiments, the first section 602 may be between 0.4-1.2 mm in thickness. The second section 604 may be between 0.8-1.6 mm in thickness. The third section 606 is between 1.2-2.0 mm in thickness. The overall width of the energy return strip 410 may be about 2.5-6 cm in width. Overall length of the energy return strip 410 may be about 13-20 cm in length.

In some particular embodiments, as illustrated by FIG. 6C, the first portion 602 of the energy return strip 610 may be comprised of two (2) layers of glass fiber 621 & 622. The second portion 604 may be comprised of three (3) layers of glass fiber 621, 622 & 641. The third portion 606 may be comprised of four (4) layers of glass fiber 621, 622, 641 & 661 and one (1) carbon fiber layer 662. The layers may be laminated together to provide energy return strips 410 & 610 with the desired thickness, stiffness and elasticity. Dependent upon the wearer's foot size and weight, alternate embodiments of the energy return strips 410 & 610 may include more or fewer layers of glass and/or carbon fiber material in order to achieve desirable properties.

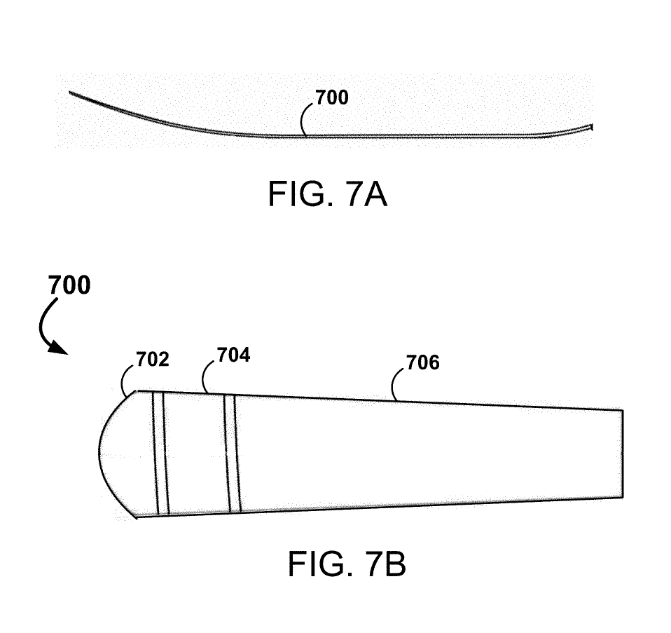

FIGS. 7A and 7B are example side and top view illustrations, respectively, of a second embodiment 700 of the energy return strip of the therapeutic shoe sole, in accordance with some embodiments. The second example embodiment 700 likewise may comprise three sections 702, 704 and 706, respectively. These sections may likewise be about 0.4-1.2 mm in thickness, 0.8-1.6 mm in thickness, and 1.2-2.0 mm in thickness for the three sections, respectively. Layering compositions may also mirror the energy return strip 410. However, unlike the energy return strip 410, the second embodiment may be substantially symmetrically shaped along the longitudinal axis. Further, the end of the third section 706 may curve up at the end, as is evident at FIG. 7A. Lastly, this embodiment may be substantially longer than the energy return strip 410. For example, the second embodiment 700 may be about 20-32 cm in total length. This enables the second embodiment energy return strip 700 to extend further down the length of the sole, enhancing support and increasing ease of mobility on the toe-off stance.

As previously noted, the energy return strip 410 or 700 reduces the effort required in the toe-off stance while walking. By way of further explanation, when the ball of the foot touches the ground, and the toes are bent, the energy return strip provides force to reduce the stress focus on the toes, and assists the foot to easily lift upward. This reduces the energy required to roll from the oblique axis to the hallux on the traverse axis.

### III. Methods of Manufacturing

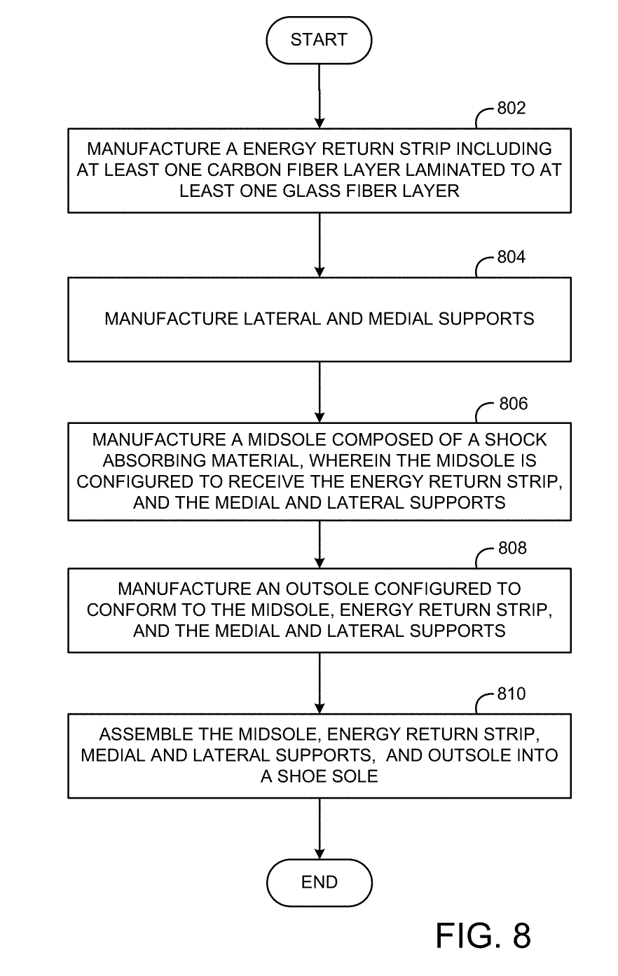

FIG. 8 is an example flow chart diagram for the manufacturing of the therapeutic shoe sole, in accordance with some embodiments. The process begins (at 802) with the manufacturing of an energy return strip including at least one layer of carbon fiber laminated to at least one layer of glass fiber. In some embodiments, the energy return strip may be curved, and have varying thickness at different sections. The section may additionally include different layer compositions.

For example, some embodiments of the energy return strip may include three sections; the first section about 0.4-1.2 mm in thickness and comprised of two layers of glass fiber, the second section about 0.8-1.6 mm in thickness and comprising three layers of glass fiber, and the last section about 1.2-2.0 mm in thickness and comprising four layers of glass fiber and one layer of carbon fiber. Note that more, or fewer, layers are considered within the scope of this disclosure. Further, alternate or additional layers of differing materials are considered within the scope of this disclosure, such as resin layers, additional carbon fiber layers, metals and plastics.

After manufacture of the energy return strip lateral and medial supports may be manufactured (at 804). In some embodiments, the lateral and medial supports may be comprised of plastic, resin, metal, carbon fiber, or other material of suitable rigidity. The lateral and medial supports may, in some embodiments, be L shaped and configured to conform to the outside and inside of the sole.

Next, a midsole is manufactured (at 806) which is configured to conform to the energy return strip and the lateral and medial supports. The midsole may be manufactured from a suitable material for shock absorption, foot comfort, weight, and moisture properties. In some embodiments, the midsole gradually thickens from the toe region of the sole to the heel region of the sole. Additionally, at the heel region of the midsole there may be a silicon pad, or other shock absorption material. Cutouts may be made in the midsole to reduce weight at the arch and heel regions.

Further, an outsole is also manufactured (at 808) which is configured to adhere to the midsole, energy return strip, and lateral and medial supports. The outsole may be any suitable material, but in some embodiments may include natural rubber or synthetics, such as polyurethane. Outsole material may be selected for coefficient of friction, wear, softness, and workability. The outsole may have treads designs molded into the material for aesthetic purposes, and to ensure better grip on surfaces.

The sole may then be assembled (at 810) by coupling the outsole, lateral and medial supports, energy return strip and midsole together utilizing stitching, adhesives, or other known techniques. This concludes the manufacturing of the complete therapeutic sole.

### IV. Data Collecting Therapeutic Shoe Sole

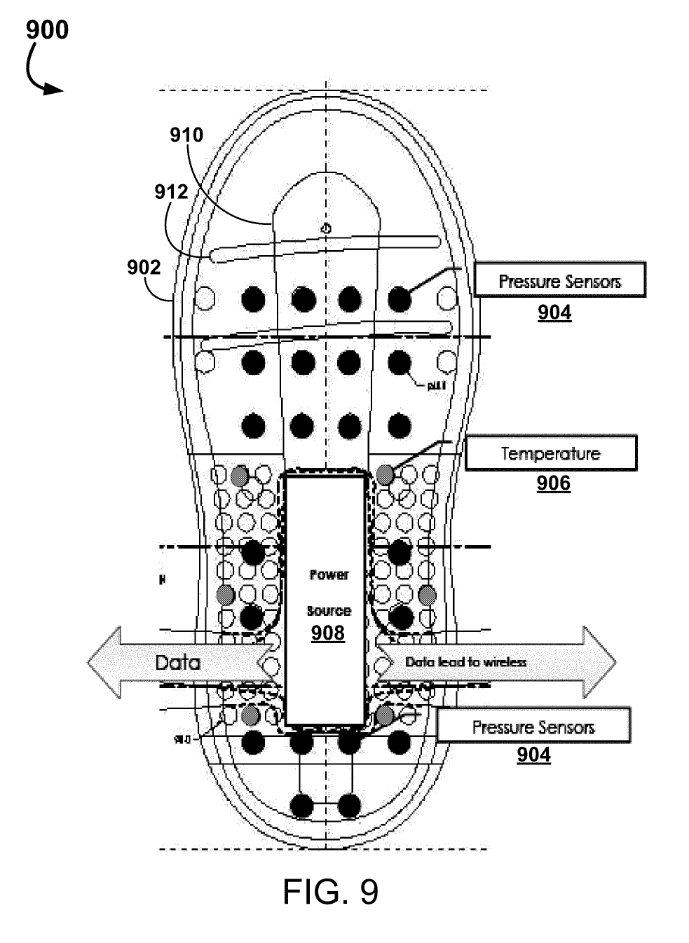

Lastly, in some embodiments, it may be desirous to generate a shoe sole capable of collecting and transmitting data regarding the wearer for therapeutic purposes. FIG. 9 is an example cross sectional top view illustration of a data feedback embodiment of the therapeutic shoe sole, in accordance with some embodiments, and shown generally at 900. The basic structure of this shoe sole is similar to previous embodiments in that a midsole 902 couples to an energy return strip 910. One or more perpendicular supports 912 may also be included within the midsole to further increase foot support. Alternatively, in some other embodiments, the data collection and utilization aspects detailed below in relation to this sole design may be independent of the energy return strip 910 and other support features detailed above.

Key differentiating elements of this sole is the presence of a power source 908 and a plurality of pressure sensors 904 across the ball/pad, arch and heel regions of the sole. Additionally, one or more temperature sensors 906 may record the foot's temperature. Pressure and temperature data may be recorded and periodically downloaded by a physician or wearer, or may be continually transmitted via a wireless interface. The collected pressure and temperature data may inform the wearer or physician as to the wearer's gait and physiological condition. This data may be utilized to tailor therapy, or modify behavior.

Additionally, in some embodiments, the sole may include an imbedded computer which may be programmable to adjust the sole temperature and/or plantar pressure to prevent foot ulceration. Such a sole may be of particular use for military shoe applications, shoes targeting diabetic wearers, and safety shoes.

The programmable imbedded computer may monitor foot pressures and temperatures using the pressure sensors 904 and temperature sensors 906, respectively. When uneven or excessive pressure is sensed the computer may drive pumps capable of inflating bladders within the sole to adjust plantar pressures. Alternatively, actuators and mechanical means may be utilized to adjust plantar pressure. When temperatures at the sole are uneven or excessive the programmable imbedded computer may adjust sole temperature to prevent thermal necrosis due to pressure and friction. Temperature modulation may include utilizing air circulation, fluid circulation via embedded fluid channels, and/or peltier (solid state) cooler.

In some embodiments, the insole may include a tri-laminar structure with a top layer that is comprised of 3D porous individual cells made of polyethylene and synthetic polymer. This 3D polymer structure may be configured to facilitate air movement. In some embodiments, the cell structure may resemble a matrix of polymer beads; however, alternate structures and 3D designs are considered within the scope of this disclosure. In these embodiments, the cell density/hardness may be modulated by the imbedded computer. Likewise, in these embodiments, the imbedded computer may also control air flow-ability within the 3D polymer layer.

Further, in some embodiments, the programmable computer may further include a global positioning system (GPS) for position tracking. Such a system may be of particular use for emergency workers, military personnel, and Alzheimer's or dementia patients.

### V. Additional Embodiments

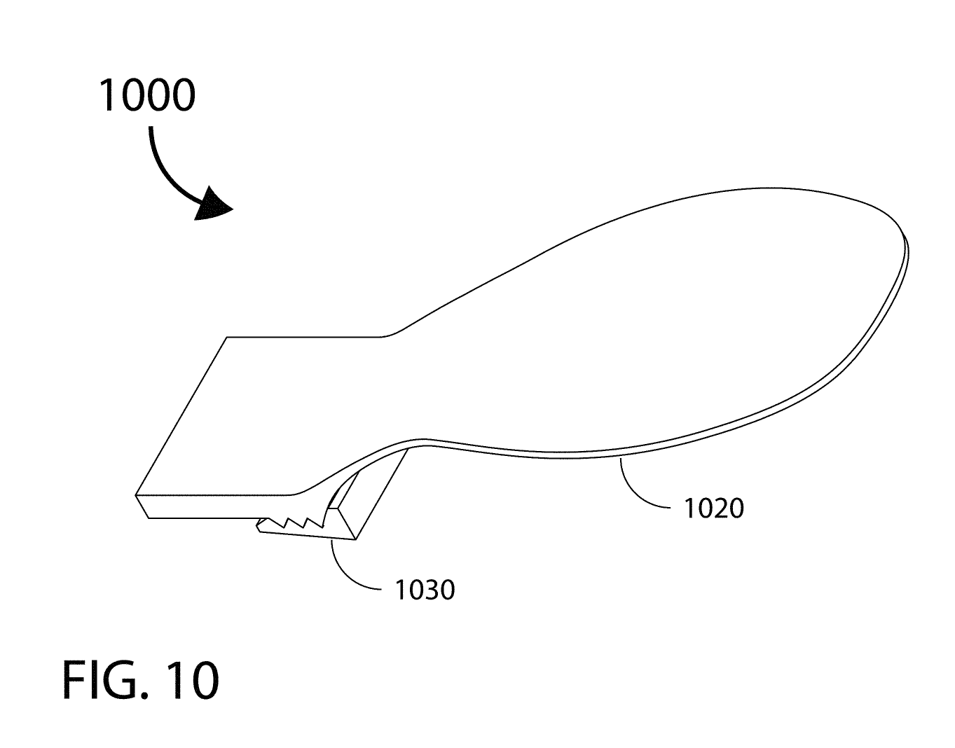

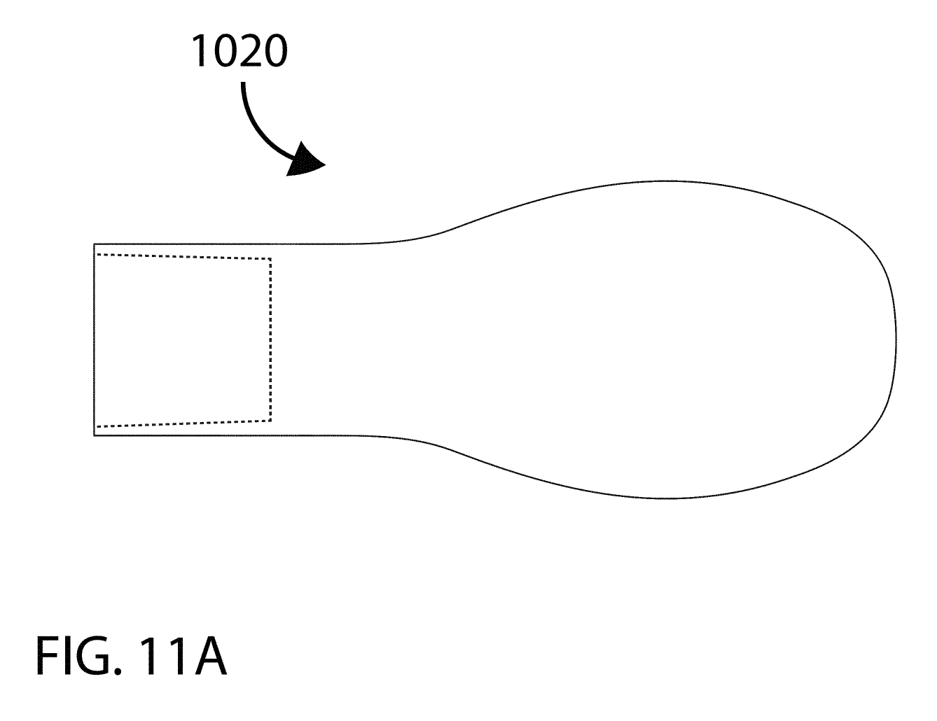

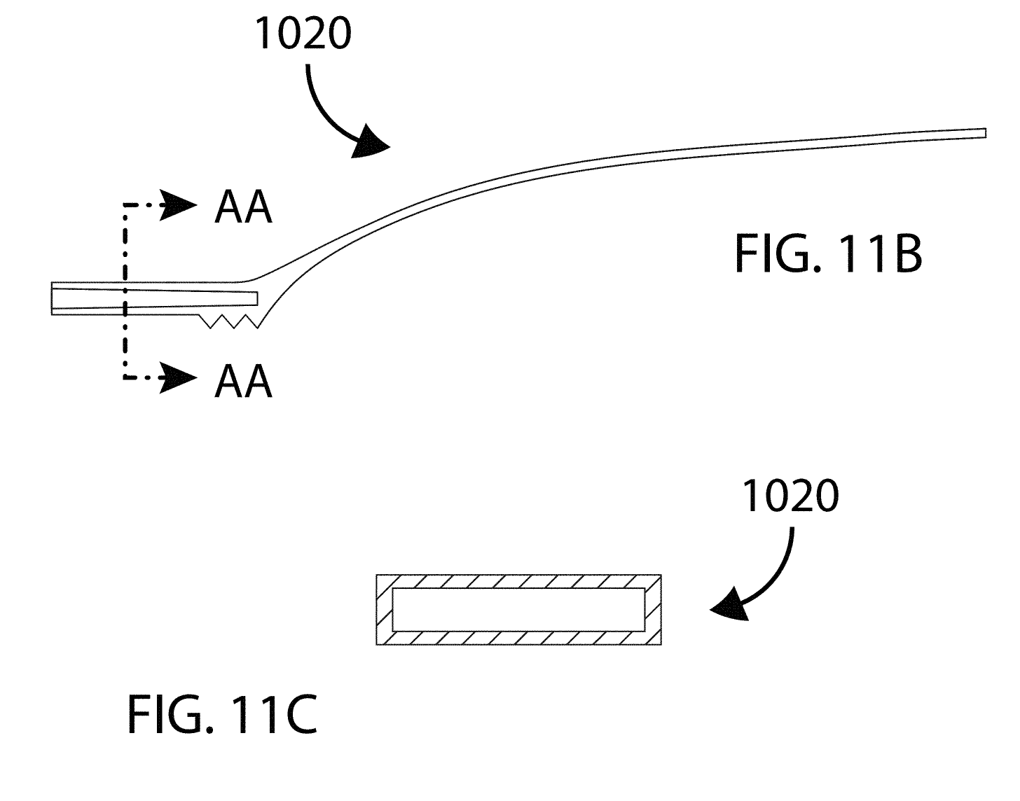

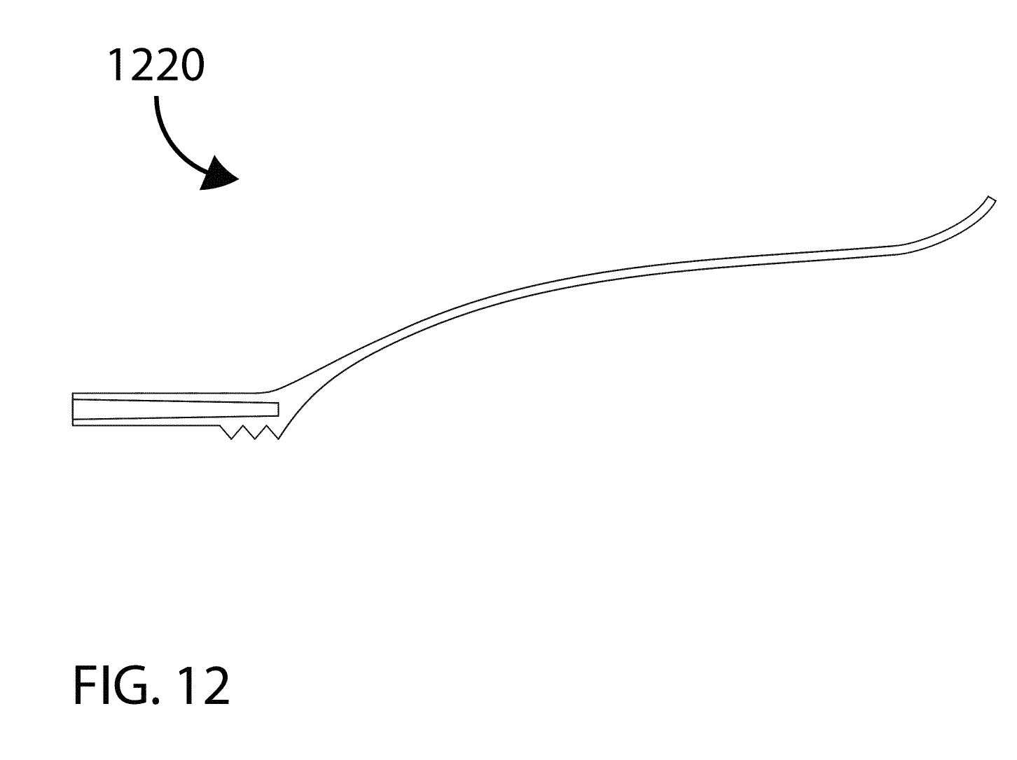

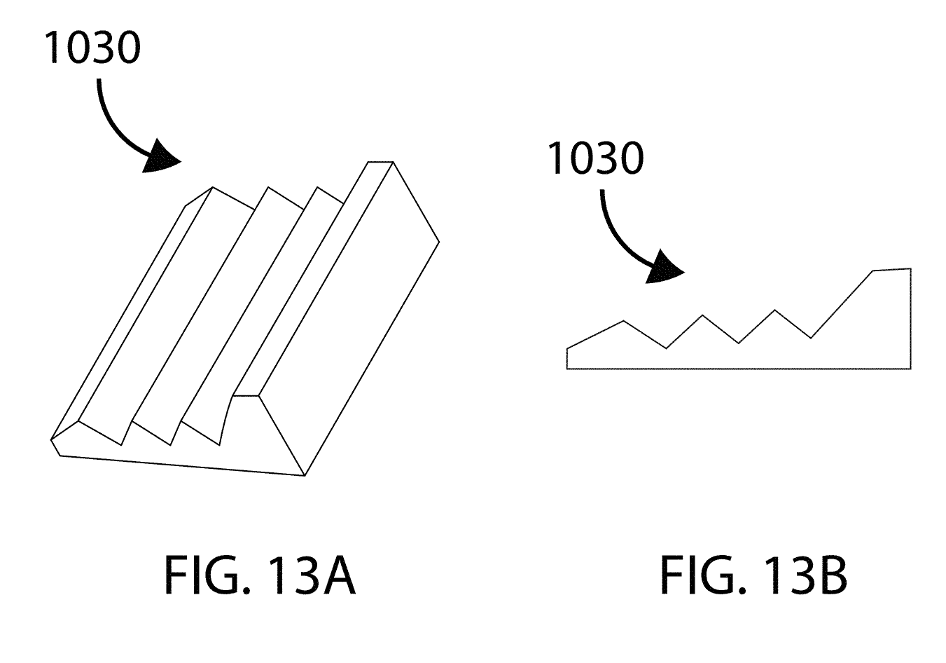

In accordance with the present invention, as illustrated by FIGS. 10-16B & 17A-17E, one embodiment of an energy returning shoe 1400 includes an energy returner having a front lever arm 1410, a rear lever arm 1020, and an adjustable base 1030. FIG. 10 is a perspective view of rear lever arm 1020 attached to base 1030. FIGS. 11A, 11B and 11C are top view, side view and cross-sectional AA-AA view, respectively, of rear lever arm 1020. FIG. 12 is an elongated version of rear lever arm 1020. FIGS. 13A and 13B are perspective and side views of base 1030.

The energy returner can be a gait restorer functioning as therapeutic aid for an arthritic patient or an injured patient. Alternatively, the subject can have a physically demanding occupation such as a first responder, a military service personnel or a tradesperson, and the energy returner can substantially reduce risk of lower extremity stress fractures.

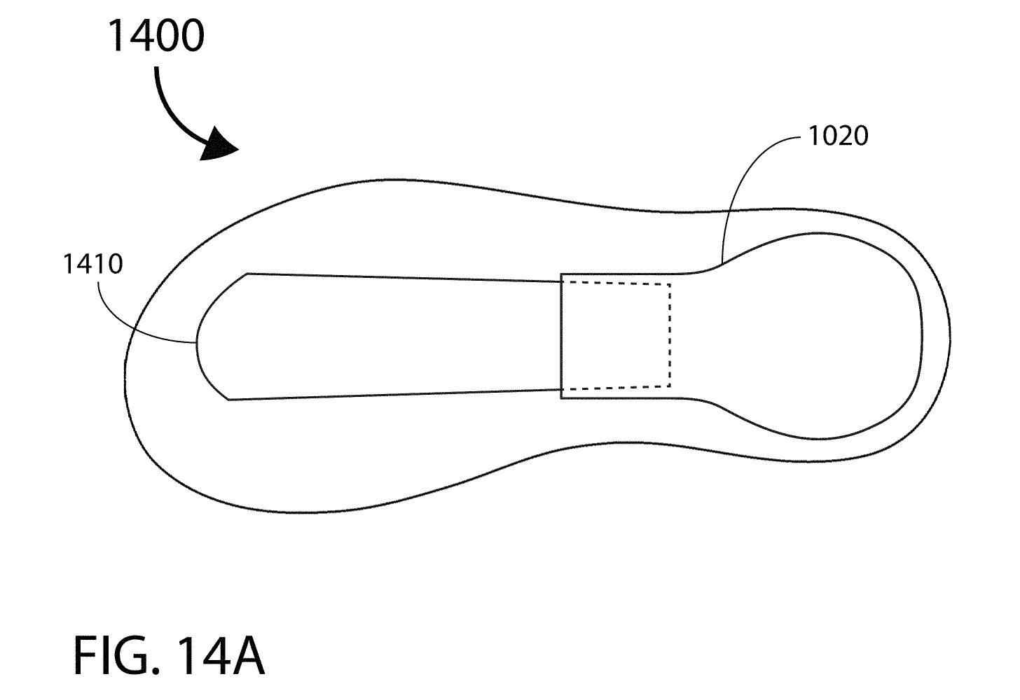

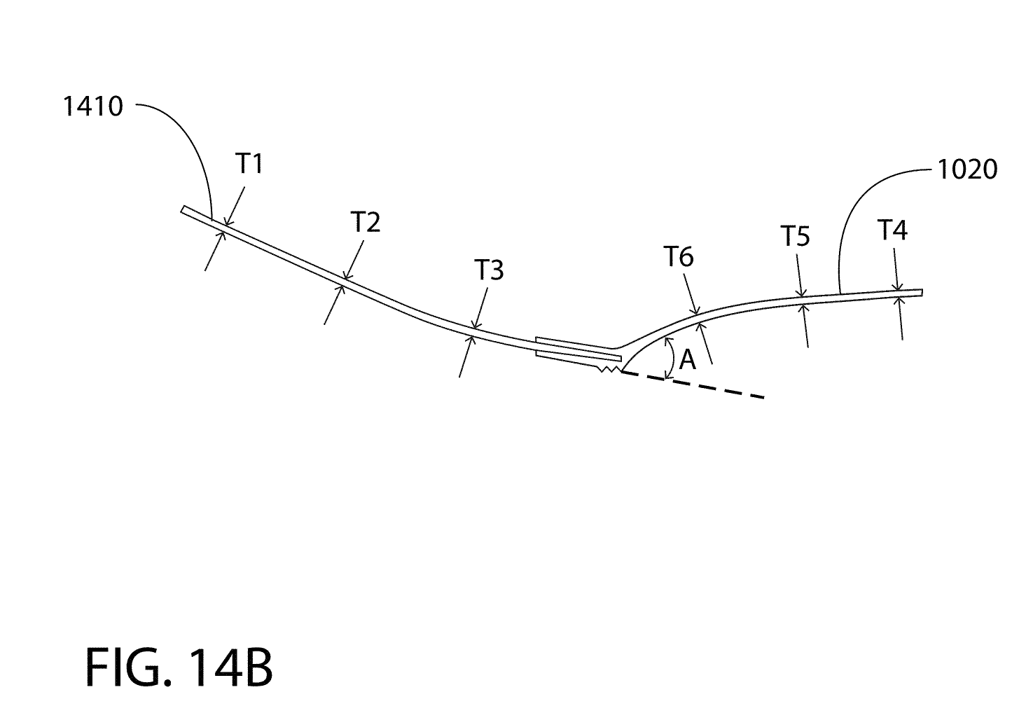

FIG. 14A is a top view of showing front lever arm 1410 and rear lever arm 1020 installed in the shoe 1400, while FIG. 14B is a side view of front lever arm 1410 inserted into rear lever arm 1020.

In this embodiment, the rear lever arm 1020 is pre-sprung and can include a plurality of laminated composite and/or carbon graphite fibers. In this example, for a subject weighting 180 to 220 pounds (with or without specialized uniform and/or equipment). Front lever arm 1410 can taper from T1 (e.g. one or more layer approximately 1 mm thickness), to T2 (e.g. two or more layers approximately 2 mm thickness) and to T3 (e.g. three or more layers approximately 3 mm thickness). Similarly, rear lever arm 1020 can taper from T4 (e.g. one or more layer approximately 1 mm thickness), to T5 (e.g. two or more layers approximately 2 mm thickness) and to T6 (e.g. three or more layers approximately 3 mm thickness). The respective thicknesses can be reduced or increased by, for example, 30% for lighter and heavier subjects, including any specialized uniform and/or equipment.

Further, rear lever arm 1020 can be pre-sprung angularly (A) approximately 12 to 18 degrees, thereby allowing for the creation of torque and force resulting in increased mobility.

In this embodiment, an exemplary combined pre-spring force (“F_{A}”) for the energy returner of shoe 1400 for the subject whose gross weight (including any specialized uniform and/or equipment) is “W”, can be computed using the following equation:

(W*4.48)(d₁)cos₁)F_{A}(d₂)(cos₂)
d₂=pfMA (Plantar Flexor Moment Arm or Heel Bone)
d₁=distance between front of First Ray and pfMA

In this example, the subject's gross weight “W” is approximately 200 pounds and the subject's foot length is about 10 inches (250 cm). Linear values “d₁” and “d₂” are 17.7 cm and 5.8 cm, respectively. Trigonometric cosine values “cos₁” and “cos₂” are 5 degrees and 15 degrees, respectively. Accordingly, as shown in the exemplary computation below, to substantially resist the load of bending at the subject's toes, the combination of rear lever arm 1020, front lever arm 1410 and adjustable base 1030 enhance the subject's mechanical performance with a combined pre-sprung force “F_{A}” of about 596 lbf.

$${F}_{A} = \frac{896 N ( 17.7 cm ) ( cos 15 )}{( 5.8 cm ) ( cos 5 )}$$

$${F}_{A} = 596 lbf$$

Construction of front lever arm 1410 and rear lever arm 1020 can be similar to that described above for energy return strip 410. As shown in FIG. 14B, front lever arm 1410, which can be made of a composite fiberglass that may be laminated with high strength fibers such as carbon fiber, is configured to be inserted into a slot of rear lever arm 1020. With this lever arm combination, the energy returner aids the subject by producing the dorsiflexion during the swing phase and controls it through a unique “flatter elasticity velocity ratio”. As a result, the shoe 1400 provides a rotational stability that allows for better control of the subject's body mass with or without heavy equipment and/or uniform.

According to Wolfe's Law there is physiological tissue mechanical homeostasis cycle also known as a sustainable cycle. As part of this cycle the subject's body endures an internal stress distribution that leads to an energy efficient stress distribution. This in turn brings about muscle activation that ultimately results in tissue remodeling. In addition to the cycle to sustaining our existing tissue, there also exists a degenerative cycle. This cycle is the tissues response to physiological stress shielding. As part of this cycle, stress shielding leads to an internal force imbalance which can present as localize limitations and mechanics. This imbalance will then leads to irregular muscle activation which can be either neurological or biomechanical and then ultimately ends with tissue regeneration.

Note that this joint between rear lever arm 1020 and front lever arm 1410 can be additionally customized for the subject's unique biomechanics, by simply relocating adjustable base 1030. Adjustable base 1030 enhances body mass control for the subject, via the plantar flexor tendon. Base 1030 can be a customized viscoelastic composite part and its placement alters the gear ratio which is the ratio for the length of front lever arm 1410 over the length of rear lever arm 1020. This ratio dictates the rotational stability of the ankle joint and an increase in this gear ratio there will be a quicker response between the surface and the ankle joint by slowing shortening the plantar flexor tendon and aiding to maintain force production.

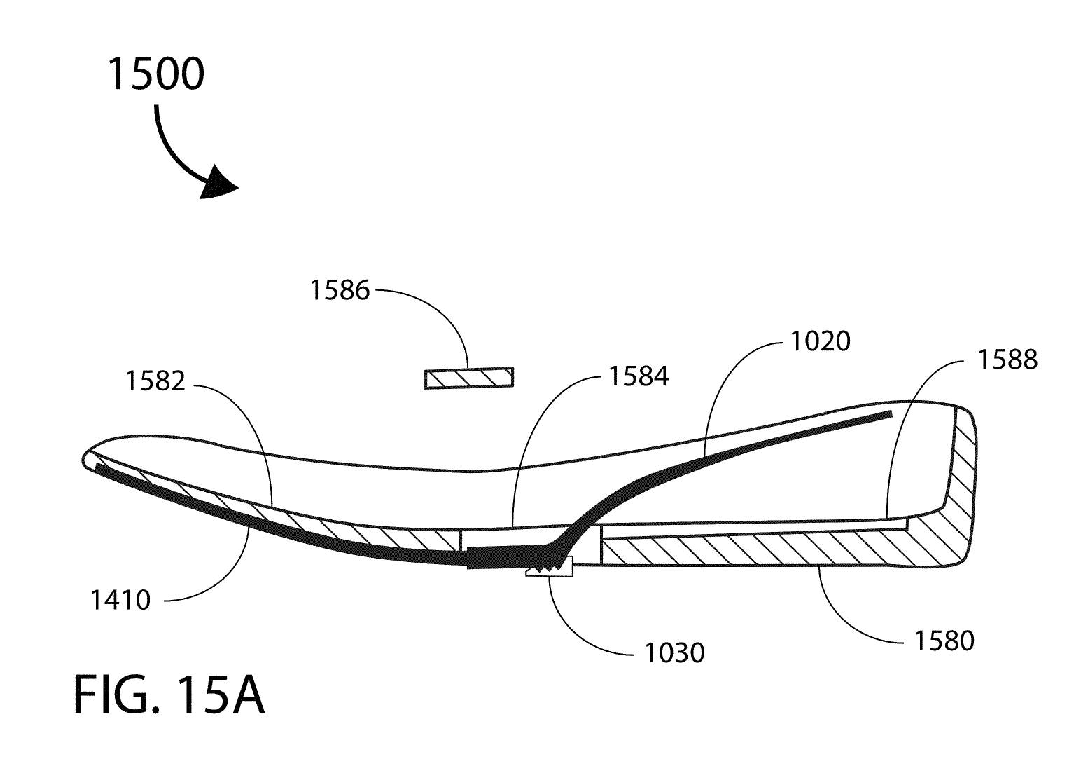

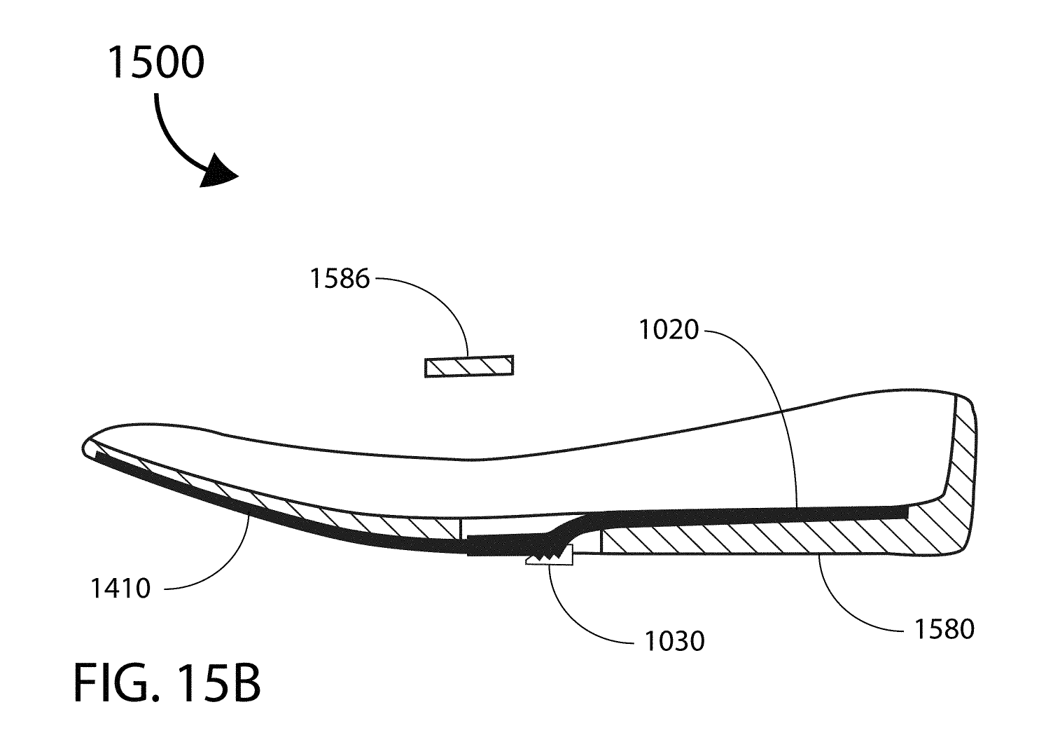

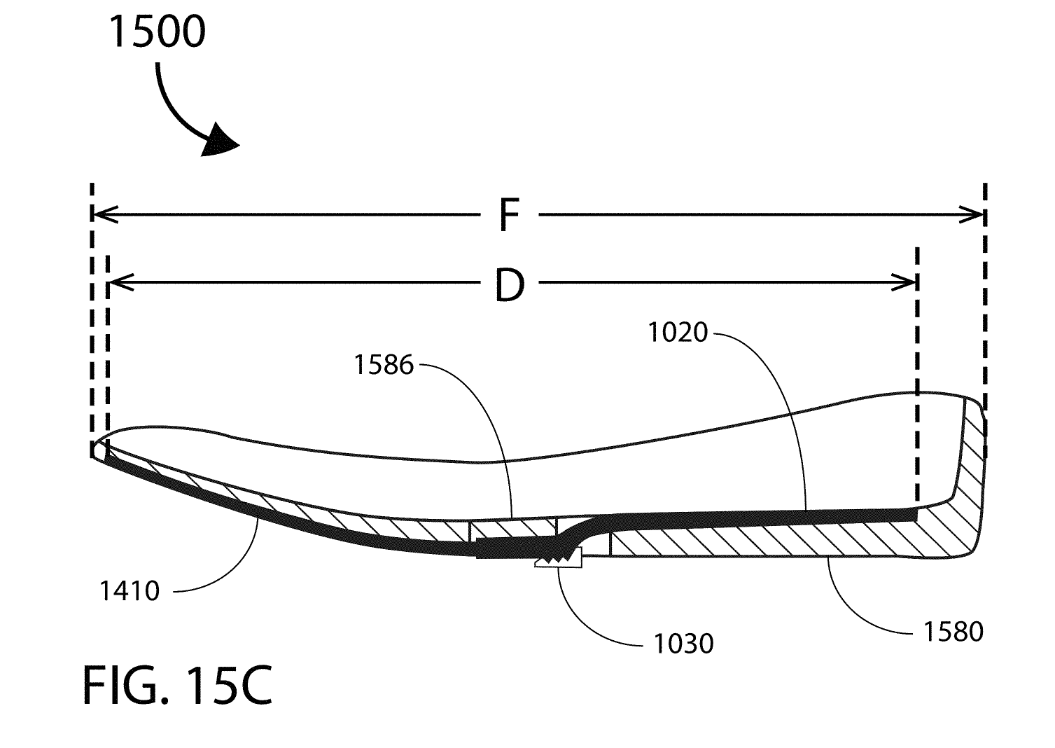

Referring now to FIGS. 15A and 15B, in some embodiments, an exemplary manufacturing process for middle shoe sandwich 1500 is described as follows:
1. Using a cutting knife, a hole 1584 (approximately 48 mm×45 mm) is made within insole 1580 at the center of pressure. The specific location of the hole 1584 can be customized for each subject. Note that the cutout 1586 is retained for later use. Insole can be made from a suitable material such as EVA.
2. Front lever arm 1410 is laminated together with a corresponding front recess of insole 1580 using a heat source or a suitable adhesive at room temperature.
3. Rear lever arm 1020 is coupled to front lever arm 1410 by inserting the exposed portion of front lever arm 1410 into a corresponding mating slot of rear lever arm 1020.
4. The base 1030 is positioned and attached, e.g., glued, at the center of pressure under rear lever arm 1020.
5. Place the previously retained cutout 1586 back over the hole 1584 and the rear lever arm 1020 is laminated to a corresponding rear recess 1588 of the insole 1580 using a heat source or adhesive to securely hold resulting structure in place.

Note that the above described sequence is exemplary and may be reordered within the spirit of the present invention. As shown in FIG. 15B, the ratio of “D” (length of lever arm combination) is generally between 70-90% of “L” (length of subject's foot).

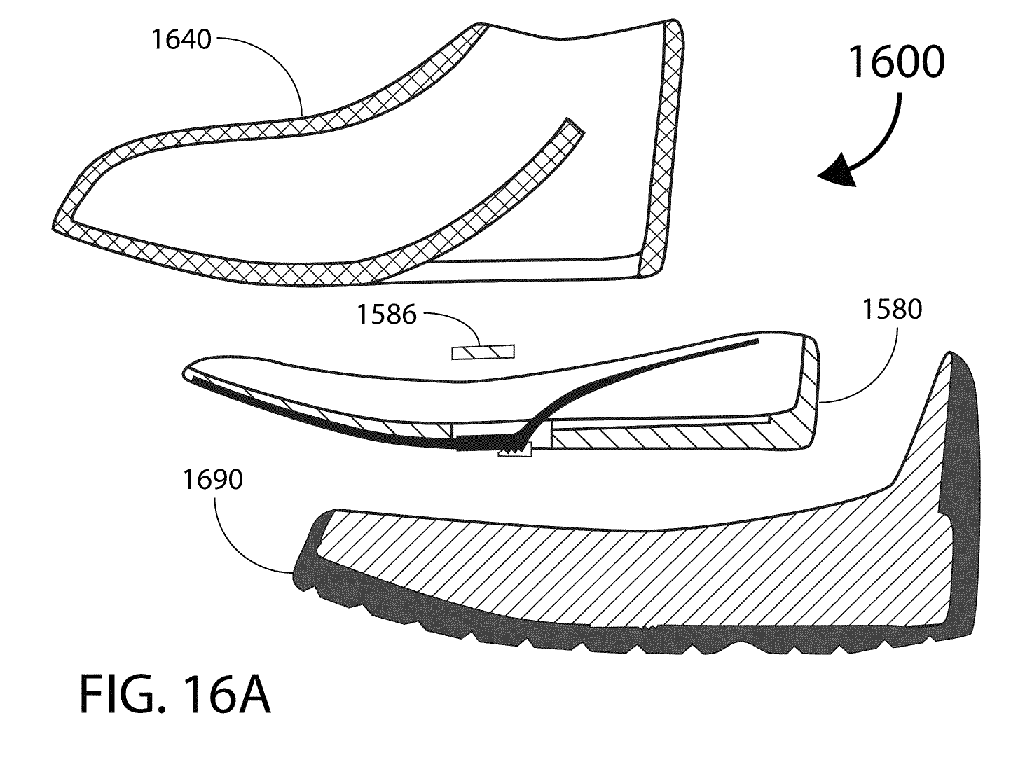

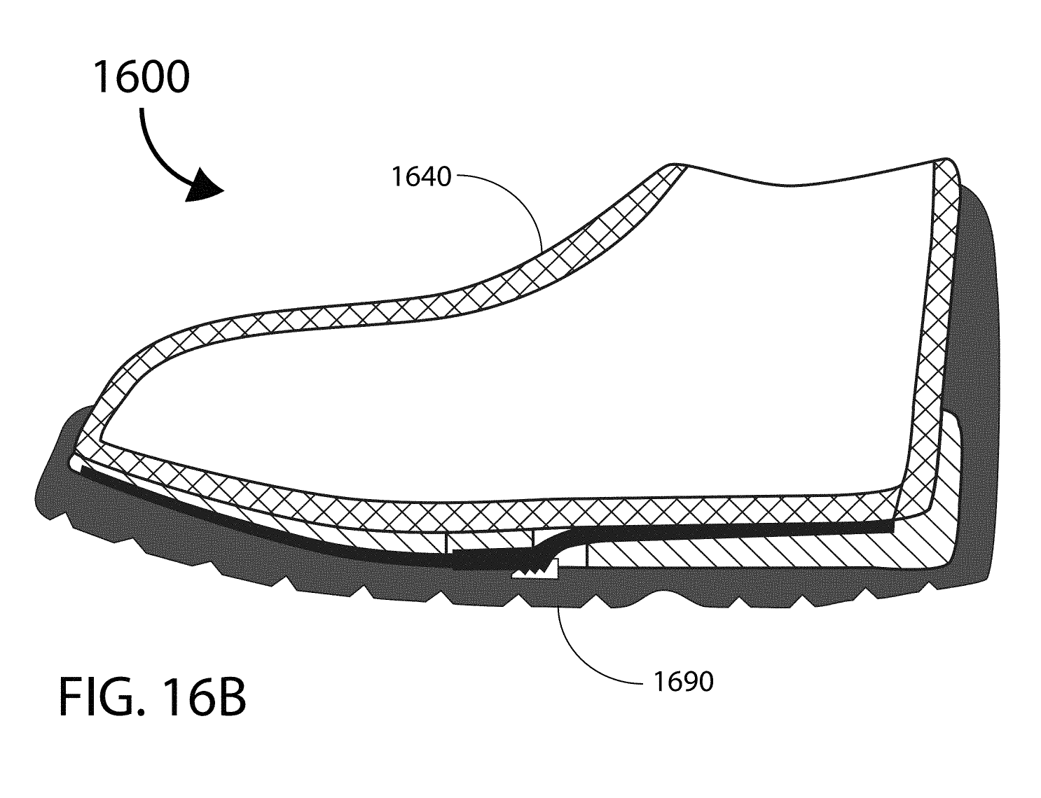

Hence, as shown in FIGS. 16A-16B, an energy returning shoe 1600 can be constructed using insole 1580 (with lever arm combination 1410 & 1020) configured to be sandwiched between a shoe upper 1640 and an outer sole 1690.

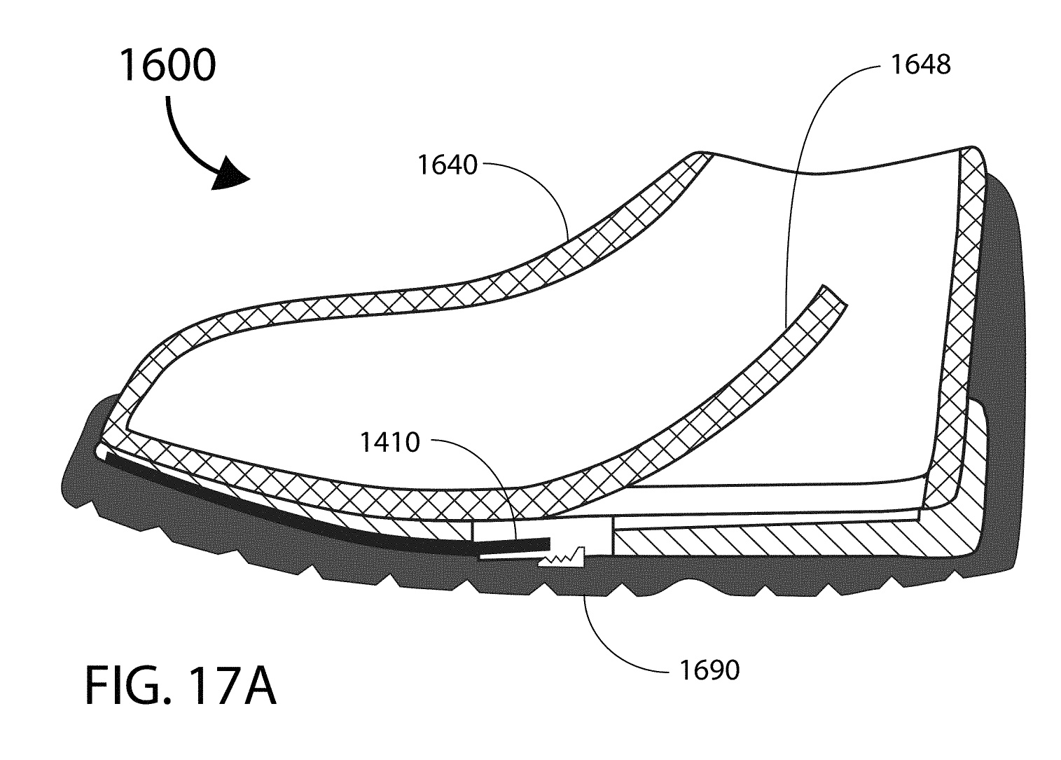

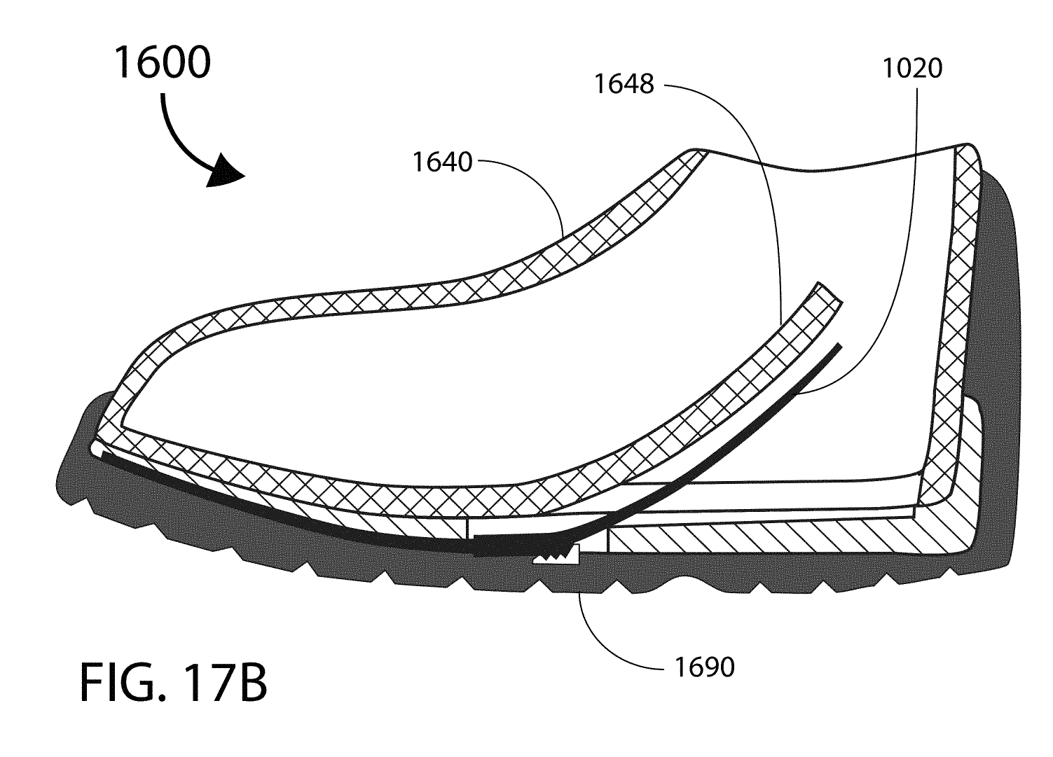

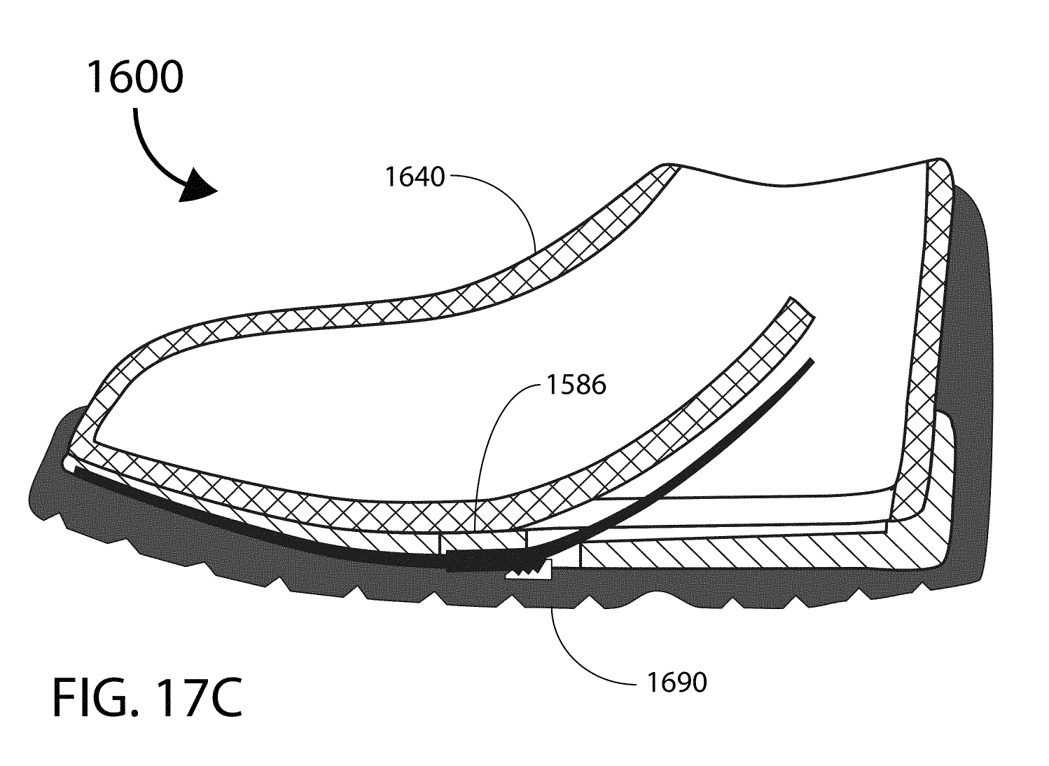

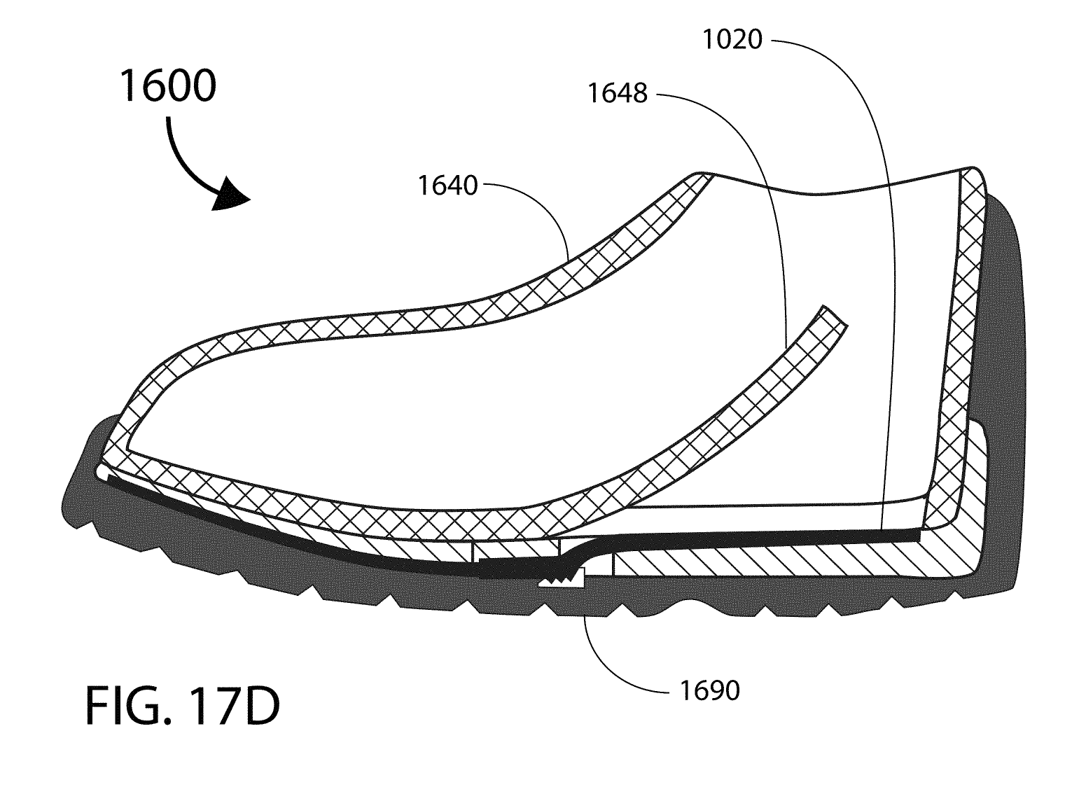

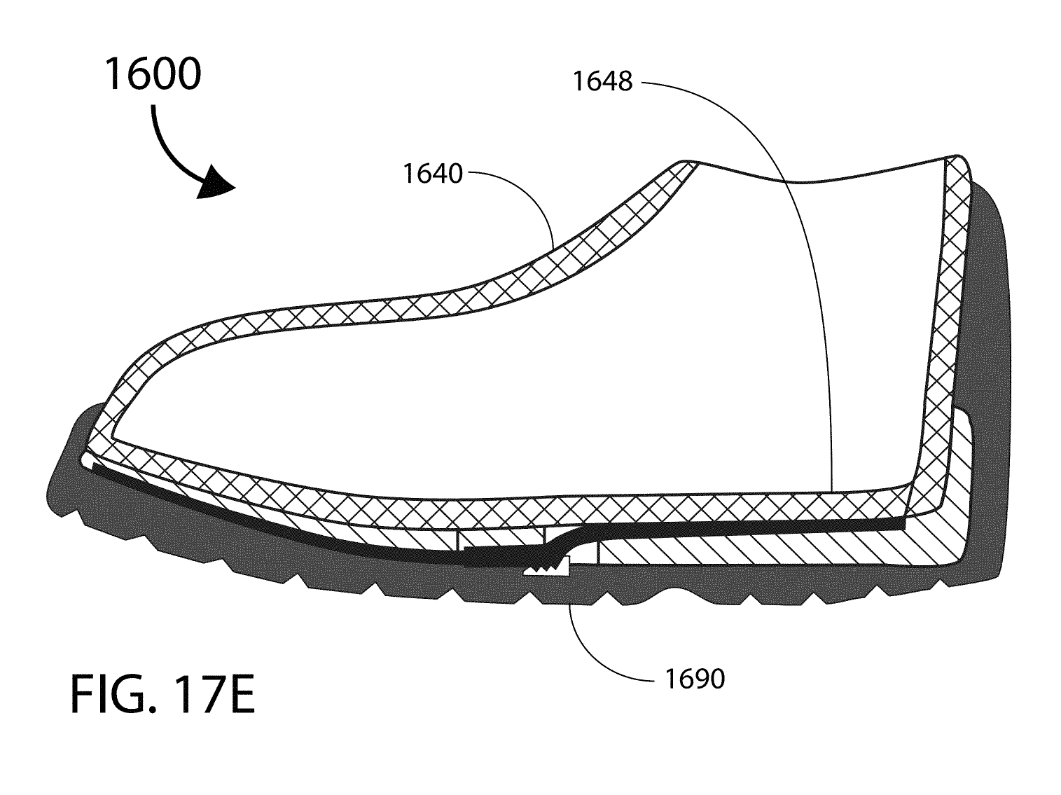

As illustrated by FIGS. 17A-17E, in some embodiments, shoe upper 1640 includes a bottom rear flap 1648 to facilitate one or more personalized customization(s)/fitting(s) of the shoe 1600 to a specific foot of the subject after initial production, i.e., after shoe upper 1640, midsole middle shoe sandwich 1500 and outer sole 1690 have been pre-assembled together.

In FIG. 17A, rear flap 1648 is lifted to expose the front lever arm 1410. As shown in FIG. 17B, rear lever arm 1020 can be coupled to front lever arm 1410. The cutout 1586 can also be inserted to fill in the gap between the top of the rear lever arm 1020 and the bottom of the shoe upper 1640 (see FIG. 17C).

Referring to FIG. 17D, the rear lever arm 1020 can now be secured to the corresponding rear top recess of midsole 1580. To facilitate follow-up refitting session(s) to, for example, tryout different pre-sprung forces using a stronger or a weaker rear lever arm 1020, a removable adhesive can be used to temporarily secure rear level arm 1020. As shown in FIG. 17E, the rear flap 1648 can also be temporarily reattached to the shoe upper 1640, thereby permitting follow-up refitting session(s), for optimizing the shoe 1600 to the specific foot of the subject by replacing/relocating rear lever arm 1020, e.g., re-optimizations over time as the subject recovers from an injury.

Bottom rear flap 1648 can also include a rear window (not shown) made from a clear material so that an identification code of the rear lever arm 1020 is visible through the shoe upper 1640. In addition, shoe upper 1640 can also include a front bottom window (not shown) to permit identification of the front lever arm 1410 after shoe assembly.

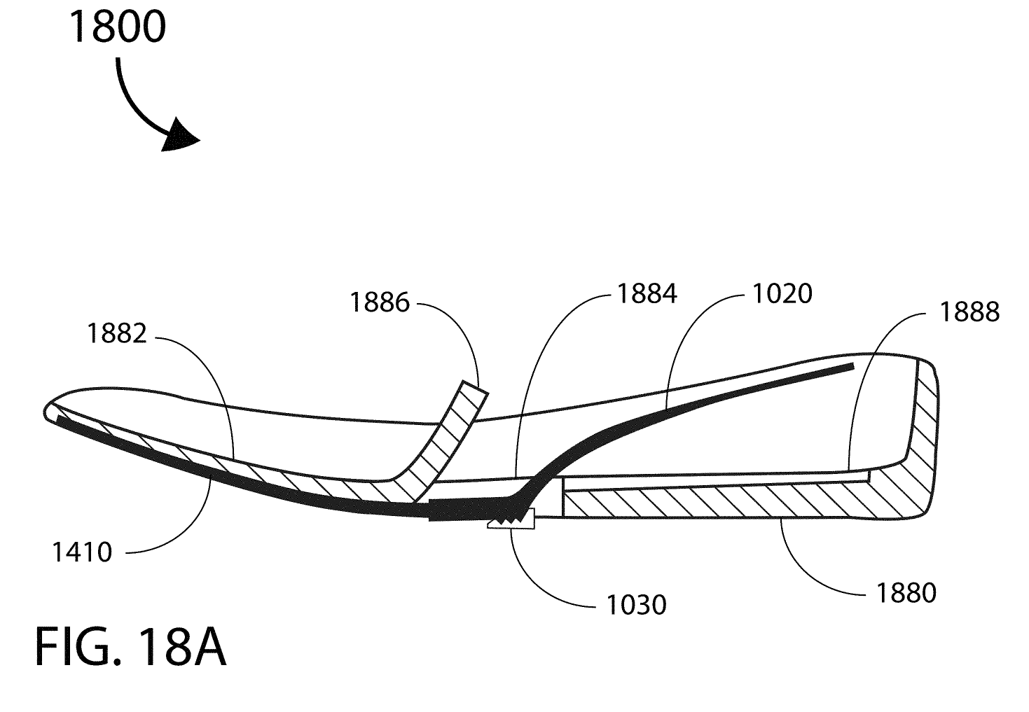

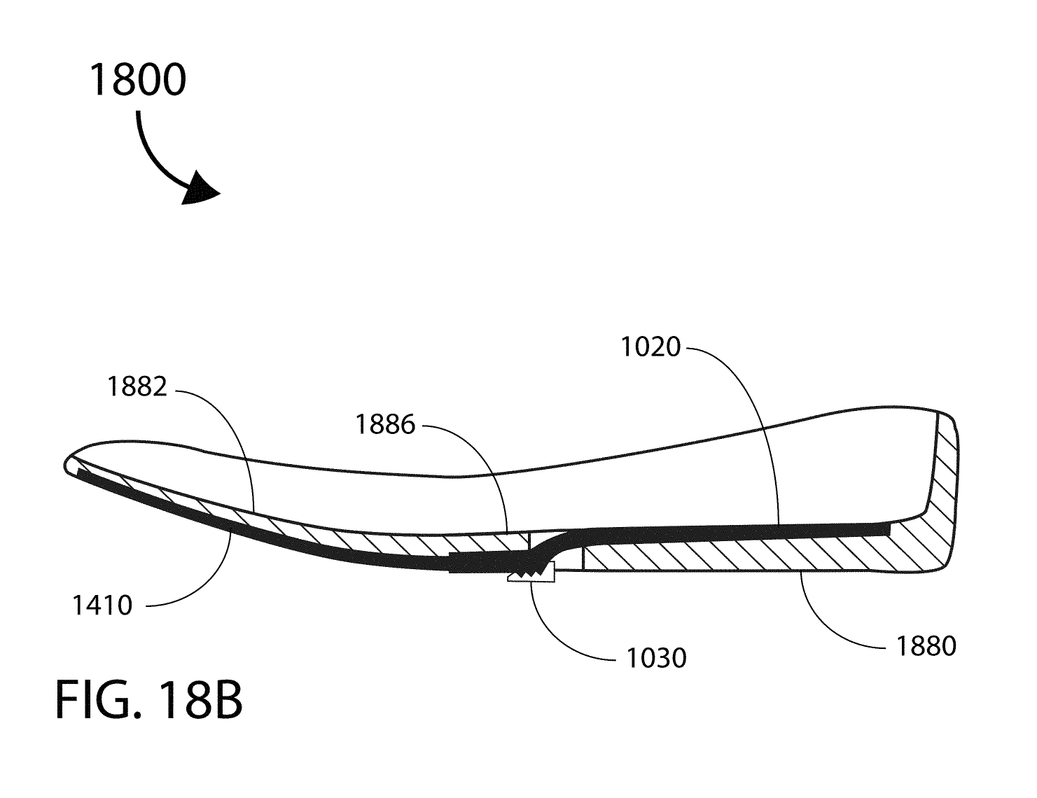

Referring to FIGS. 18A and 18B, in yet another embodiment, instead of cutout 1586 to fill in the hole 1584, a flap 1886 facilitates the assembly of middle shoe sandwich 1800.

In sum, therapeutic and/or occupational shoe soles and methods for their manufacture is provided. While a number of specific examples have been provided to aid in the explanation of the present invention, it is intended that the given examples expand, rather than limit the scope of the invention. For example, while some embodiments of the invention are illustrated with a three sectioned energy returner, it is entirely within the scope of the invention for alternate energy returner geometries, such as more sections or a single strip thickness.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. An energy returning shoe sole useful in conjunction with a subject, the shoe sole having a toe region, a ball region, an arch region and a heel region, the shoe sole comprising:
an outsole;
a shoe upper with a rear flap;
a midsole comprised of shock absorptive material, wherein the midsole is coupled to the outsole and the shoe upper; and
an energy returner configured, wherein the energy returner is integrated with the midsole via an opening in the midsole, the energy returner including:
a front lever arm configured to be secured to a front bottom recess of the midsole; and
a separable rear lever arm configured to be secured to a rear top recess of the midsole, wherein the rear lever arm includes a lever arm joint for coupling the rear lever arm to the front lever arm, and wherein the rear lever arm can be coupled to the front lever arm through the rear flap of the shoe upper after assembly of the midsole to both the outsole and the shoe upper.

2. The shoe sole of claim 1 further comprising an adjustable base configured to enhance body mass control of the subject via a plantar flexor tendon of the subject, thereby customizing for unique biomechanics of the subject by relocating the adjustable base relative to the rear lever arm.

3. The shoe sole of claim 1, wherein the lever arm joint is a slot.

4. The shoe sole of claim 1, wherein the midsole curves upward at the heel and toe regions.

5. The shoe sole of claim 1, wherein the energy returner includes sections of varying thickness.

6. The shoe sole of claim 5, wherein the energy returner includes a first section, a second section and a third section.

7. The shoe sole of claim 6, wherein the first section is about 0.5-1.5 mm thick, the second section is about 1.5-2.5 mm thick and the third section is about 2.5-5.5 mm thick.

8. The shoe sole of claim 6, wherein the first section is comprised of one or more layers of glass fiber, the second section is comprised of two or more layers of glass fiber, and the third section is comprised of three or more layers of glass fiber or carbon fiber.

9. The shoe sole of claim 1, wherein the energy returner is between 0.6 and 0.9 of a length of the subject's foot.

10. The shoe sole of claim 1, wherein the energy returner is between 2.5-8 cm in width.

11. The shoe sole of claim 1, wherein the subject is a patient, and wherein the shoe sole is configured to function as a gait restoring therapeutic aid to the patient by producing dorsiflexion during a swing phase.

12. The shoe sole of claim 1, wherein the subject is a first responder, a military personnel or a tradesperson, wherein the subject wears a uniform or carries specialized equipment, and wherein the energy returner reduces risk of lower extremity stress fractures of the subject.

13. The shoe sole of claim 1, wherein a gross weight of the subject including any uniform or equipment is “W”, and wherein the energy returner has a pre-sprung force (“F_{A}”) based on an equation:
(W*4.48)(d₁)cos₁)F_{A}(d₂)(cos₂)
d₂=pfMA (Plantar Flexor Moment Arm or Heel Bone)
d₁=distance between front of First Ray and pfMA
